(19) United States
(12) Patent Application Publication
(10) Pub. No.: US 2017/0196742 A1
(43) Pub. Date: Jul. 13, 2017

(54) WHEELCHAIR POWER-ASSISTED WHEEL

(71) Applicant: ETI CA BATTERY INC., NEW TAIPEI CITY (TW)

(72) Inventor: WEI-CHEN WU, NEW TAIPEI CITY (TW)

(21) Appl. No.: 15/075,441

(22) Filed: Mar. 21, 2016

(30) Foreign Application Priority Data
Jan. 11, 2016 (TW) 105200309

(51) Int. Cl. A61G 5/04; B62M 6/40; B60K 1/04

(52) U.S. Cl. CPC A61G 5/04; B60K 1/04; B62M 6/40

(57) ABSTRACT

A wheelchair power-assisted wheel is arranged on a wheelchair. The wheelchair power-assisted wheel includes a substrate axially connected with the wheelchair. A power-driven wheel is arranged on a lower surface of a front part of the substrate and touches the ground. A power provider is arranged on an upper surface of a back part of the substrate and electrically connected with the power-driven wheel and provides power to the power-driven wheel whereby the power-driven wheel moves against the ground. The present invention is convenient for a sitter to move on a rough road or to move uphill. The power-driven wheel of the wheelchair power-assisted wheel moves against the ground without idling, so as to improve driving efficiency, which is more helpful in moving the sitter.

This application claims priority for Taiwan patent application no. 105200309 filed on Jan. 11, 2016, the content of which is incorporated in its entirely.

### BACKGROUND OF THE INVENTION

Field of the Invention

The present invention relates to a wheelchair power-assisted wheel, particularly to a wheelchair power-assisted wheel arranged on a wheelchair and moving against the ground.

Description of the Related Art

For elders and disabled people, the conventional manual wheelchairs are walking assistive devices often used in daily life. In general, compared with an electric wheelchair, the manual wheelchair is smaller, lighter, easily-moved and conveniently-transported. However, the manual wheelchair is pushed by hands. It is inconvenient to use the manual wheelchair when the manual wheelchair moves long distance or moves on a rough road or a slope, or hands pain. Besides, when the mechanical design of the manual wheelchair is bad, the upper limbs of the sitter are easily hurt.

Accordingly, a power-assisted wheel was invented later on to help a sitter sitting in the manual wheelchair. For example, the Taiwan patent of application No. 90211130 disclosed a wheelchair power-assisted wheel structure easily assembled. A sitter is more convenient to assemble the wheelchair power-assisted wheel structure. In addition, the Taiwan patent of application No. 89205461 disclosed a wheelchair power-assisted wheel assembly which changes a length of an installment rod of the wheelchair power-assisted wheel assembly whereby the wheelchair power-assisted wheel assembly is used for wheelchairs with different widths.

Then, refer to FIG. 1. A wheel 10 of the abovementioned patent is provided with a power-assisted wheel 12, and a connection element 14 is used to fix the wheel 10 and the power-assisted wheel 12. When a battery 122 of the power-assisted wheel 12 stops providing power to a motor 124, the motor 124 uses its speed reduction gear to deadlock a driven wheel 126 of the power-assisted wheel 12 so that the driven wheel 126 is hard to rotate. Thus, the sitter is hard to push them. Additionally, the connection element 14 fixing the wheel 10 and the power-assisted wheel 12 does not have an axle. When the wheelchair moves on a rough road or moves uphill, the driven wheel 126 idles without contacting the ground so that the driving force of the power-assisted wheel 12 is not perfect. Thus, the sitter inconveniently moves.

To overcome the abovementioned problems, the present invention provides a wheelchair power-assisted wheel contacting the ground.

### SUMMARY OF THE INVENTION

A primary objective of the present invention is to provide a wheelchair power-assisted wheel, which axially connects with a wheelchair lest the power-assisted wheel jam on the wheelchair. When the wheelchair moves on a rough road, a power-driven wheel of the wheelchair power-assisted wheel contacts the ground, and a power provider provides a pressure to the power-driven wheel whose position is different from the position of the power provider whereby the power-driven wheel moves against the ground. No matter what kind of the ground the wheelchair moves on, the sitter can receive the assisted power.

Another objective of the present invention is to provide a wheelchair power-assisted wheel, whereby a sitter drives a wheelchair to move forward in electric or manual ways. The wheelchair power-assisted wheel is installed on the manual wheelchair whereby the whole weight of the wheelchair is lighter than an electric wheelchair. The wheelchair power-assisted wheel not only saves the force of the disabled sitter pushing the wheelchair but also has conveniently-carried properties. No matter how far a distance is, the sitter can use the wheelchair power-assisted wheel to easily move.

To achieve the abovementioned objectives, the present invention provides a wheelchair power-assisted wheel arranged on a wheelchair. The wheelchair power-assisted wheel comprises a substrate, a power-driven wheel and a power provider. The substrate is axially connected with the wheelchair lest the substrate jam on the wheelchair. The power-driven wheel is arranged on a lower surface of a front part of the substrate and touches the ground. The power provider is arranged on an upper surface of a back part of the substrate and electrically connected with the power-driven wheel, and provides power to the power-driven wheel whereby the power-driven wheel rotates. When the power provider moves above the ground, the energy provider provides a pressure to the power-driven wheel whereby the power-driven wheel moves against the ground.

The substrate further comprises at least one connection element axially connected with the wheelchair lest the substrate jam on the wheelchair. At least one connection element is arranged on the front part, and the power-driven wheel is arranged between the connection element and the power provider.

The power-driven wheel and the power provider arranged in an alternative and non-overlapping way. The pressure is force induced by the power-driven wheel and the power provider arranged in an alternative way.

The power-driven wheel further comprises a rim and a power driver arranged under the front part of the substrate and connected with the rim.

The power driver is electrically connected with the power provider and receives the power provided by the power provider to rotate the rim. The power driver is a direct-current (DC) brushless motor, a DC brush motor or a rim motor. The power provider is a battery or a chargeable battery.

Below, the embodiments are described in detail in cooperation with the drawings to make easily understood the technical contents, characteristics and accomplishments of the present invention.

### BRIEF DESCRIPTION OF THE DRAWINGS

FIG. 1 is a lateral view of a power-assisted wheel installed on a wheelchair in the conventional technology;

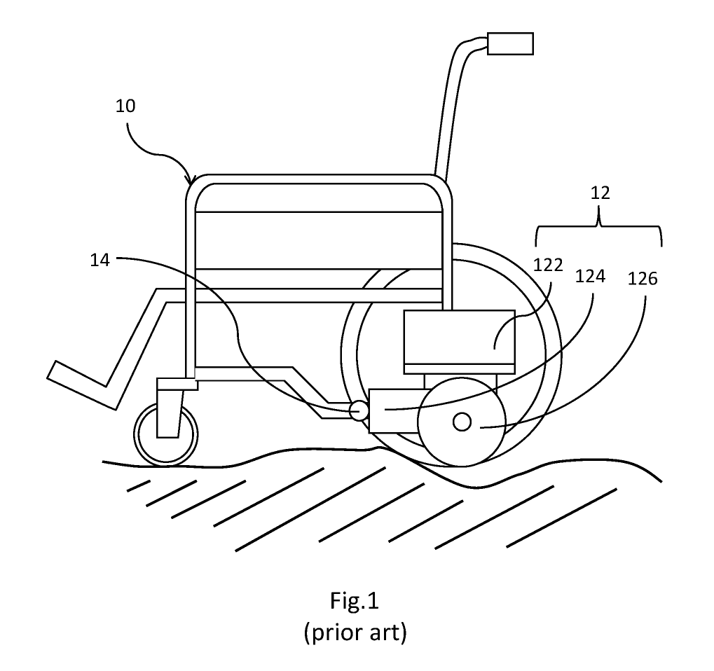

FIG. 2 is a lateral view of a wheelchair power-assisted wheel installed on a wheelchair according to an embodiment of the present invention;

FIG. 3 is a lateral view of a wheelchair power-assisted wheel according to an embodiment of the present invention;

FIG. 4 is a diagram schematically showing operation of a wheelchair power-assisted wheel installed on a wheelchair according to an embodiment of the present invention; and

FIG. 5 is a diagram schematically showing a power provider providing a pressure according to an embodiment of the present invention.

### DETAILED DESCRIPTION OF THE INVENTION

The present invention installs a wheelchair power-assisted wheel on a manual wheelchair to reduce force of a sitter himself pushing the wheelchair. No matter what kind of the ground the wheelchair moves on, the wheelchair power-assisted wheel moves against the ground lest a power-driven wheel in the wheelchair power-assisted wheel idle. As a result, use efficiency of the wheelchair power-assisted wheel is improved and causing damage to a motor due to idling is avoided.

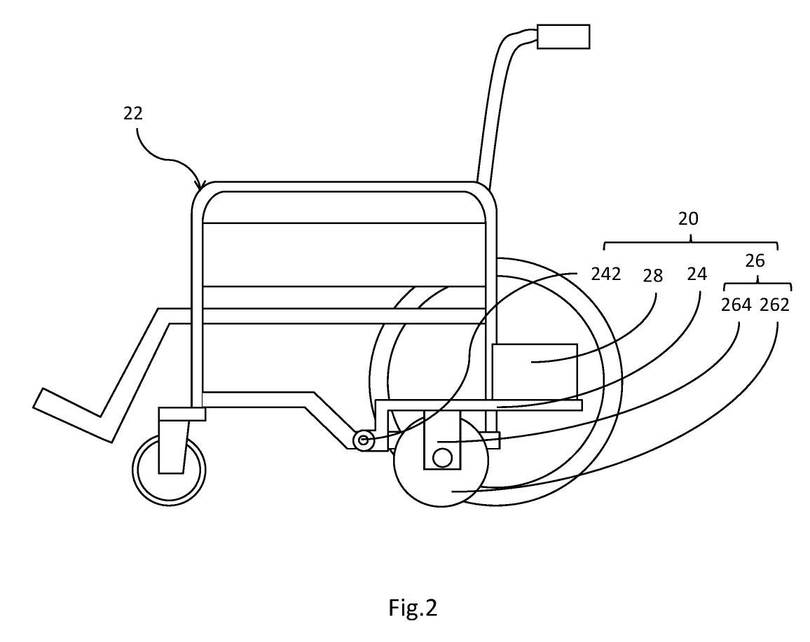

Refer to FIG. 2. A wheelchair power-assisted wheel 20 is arranged on a wheelchair 22. In the embodiment, the wheelchair 22 is a manual wheelchair. The wheelchair 22 comprises a substrate 24, a power-driven wheel 26 and a power provider 28. The substrate 24 is axially connected with the wheelchair 22. The substrate 24 further comprises at least one connection element 242 arranged on a front part of the substrate 24. In the embodiment, the connection element 242 is an axle able to be axially connected. For example, one connection element 242 is used. The substrate 24 is axially connected with the wheelchair 22 through the connection element 242. The power-driven wheel 26 is arranged a lower surface of the front part of the substrate 24 and touches the ground. The power provider 28 is arranged on an upper surface of a back part of the substrate 24 whereby the power-driven wheel 26 and the power provider 28 are arranged in an alternative and non-overlapping way. The power-driven wheel 26 is arranged between the connection element 242 and the power provider 28. The power provider 28 is electrically connected with the power-driven wheel 26. The power provider 28 provides power to the power-driven wheel 26 whereby the power-driven wheel 26 rotates. The power provider 28 is a battery or a chargeable battery. In the embodiment, the power provider 28 is exemplified by a battery.

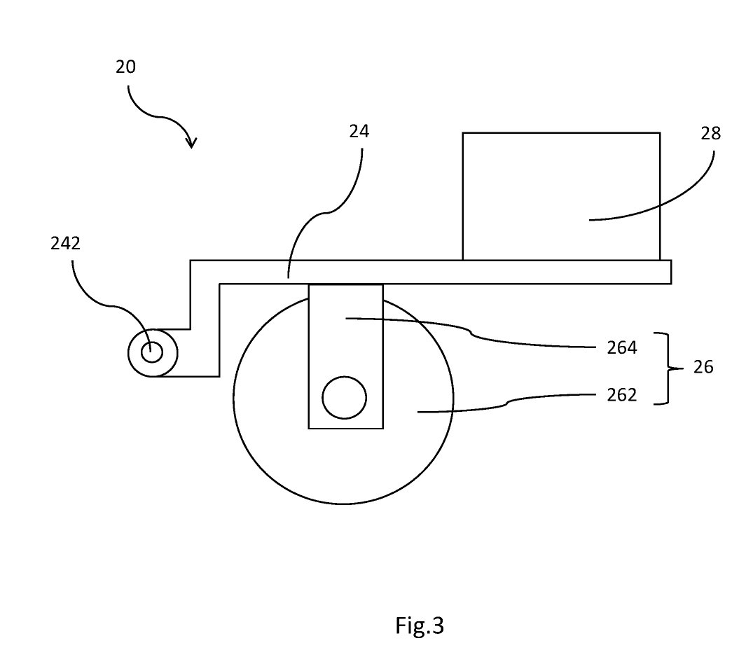

Refer to FIG. 3 to continue with the previous paragraph and explain the detailed structure of the power-driven wheel 26. The power-driven wheel 26 comprises a rim 262 and a power driver 264. The power driver 264 is arranged under the front part of the substrate 24 and connected with the rim 262. The power driver 264 is electrically connected with the power provider 28 and receives the power provided by the power provider 28 to rotate the rim 262. The power driver 264 is a direct-current (DC) brushless motor, a DC brush motor or a rim motor. In the embodiment, the power driver 264 is exemplified by a rim motor and a speed reduction gear is saved.

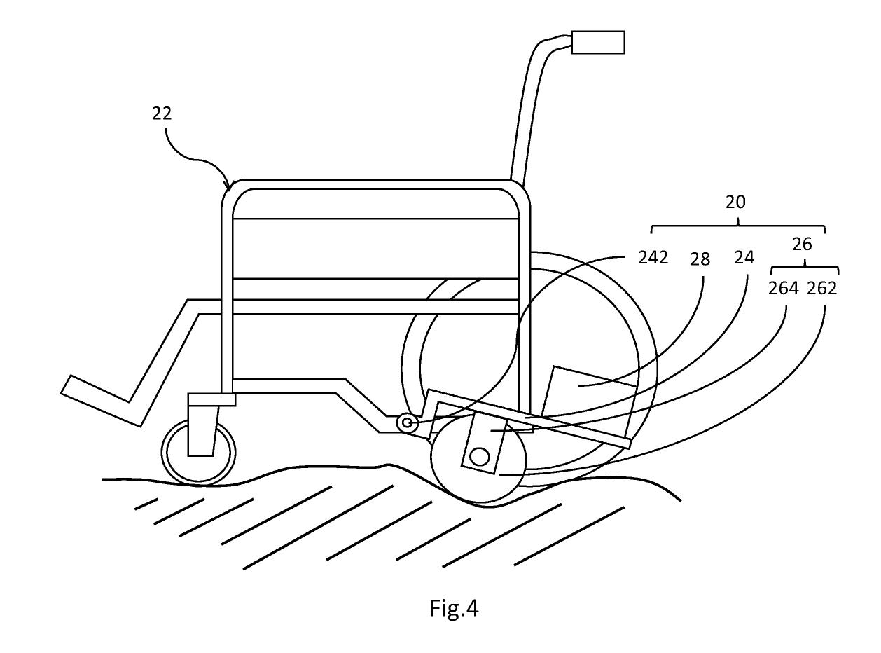

After explaining the structure of the wheelchair power-assisted wheel of the present invention, the operation of the present invention is detailed. Refer to FIG. 4 and FIG. 2. The wheelchair 22 provided with the wheelchair power-assisted wheel 20 moves on a flat road, as shown in FIG. 2. The wheelchair power-assisted wheel 20 is parallel to the surface of the road. The wheelchair 22 moves on a rough road, as shown in FIG. 4. Since the substrate 24 is axially connected with the wheelchair 22 without jamming on the wheelchair 22, the substrate 24 still rotates. Besides, the power provider 28 and the power-driven wheel 26 arranged in an alternative way induce leverage force which provides a pressure to the power-driven wheel 26 whereby the power-driven wheel 26 heaves to contact the ground and moves with the heave of the ground. Additionally, the present invention can easily rotate the power driver 264 of the power-driven wheel 26 without a speed reduction gear of the conventional technology, whereby a sitter easily pushes the wheelchair 22 to move against the ground.

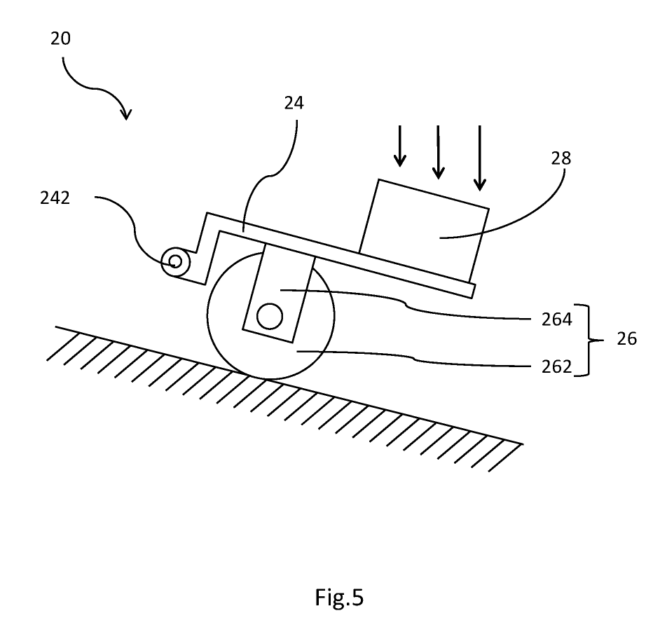

In addition to moving on the rough road, refer to FIG. 5. Since a battery nowadays is realized with a lithium battery with a lighter weight, the power-assisted wheel of the conventional technology does not easily be pressed downward due to the pressure provided by the battery weight when moving uphill. As a result, the power-assisted wheel easily idles and the sitter has to consume greater push force when moving uphill. However, since the power provider 28 of the present invention such as a battery and the power-driven wheel 26 are arranged in an alternative way, the power provider 28 provides a greater downward pressure to the power-driven wheel 26 so that the power-driven wheel 26 provides greater assisted push force to a sitter without idling when the sitter moves uphill, thereby reducing a burden of the sitter.

Consequently, the wheelchair power-assisted wheel of the present invention increases friction between tires and the ground to obtain greater driving force and to provide greater assisted push force to a sitter, whereby the sitter more easily push the wheelchair to move. Moreover, since the present invention is installed on a manual wheelchair, the present invention is lighter and more convenient than a general electric wheelchair. When the sitter has to store the wheelchair due to getting a lift, the sitter separates the manual wheelchair from the wheelchair power-assisted wheel, and then stores them. Therefore, the present invention improves easily-carried properties of the wheelchair and provides greater convenience to the sitter.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A wheelchair power-assisted wheel arranged on a wheelchair, and said wheelchair power-assisted wheel comprising:
a substrate axially connected with said wheelchair;
a power-driven wheel arranged on a lower surface of a front part of said substrate and touching a ground; and
a power provider arranged on an upper surface of a back part of said substrate, electrically connected with said power-driven wheel, and providing power to said power-driven wheel whereby said power-driven to wheel rotates, and when said power provider moves above said ground, said energy provider provides a pressure to said power-driven wheel whereby said power-driven wheel moves against said ground.

2. The wheelchair power-assisted wheel of claim 1, wherein said substrate further comprises at least one connection element axially connected with said wheelchair.

3. The wheelchair power-assisted wheel of claim 2, wherein said at least one connection element is arranged on said front part, and said power-driven wheel is arranged between said connection element and said power provider.

4. The wheelchair power-assisted wheel of claim 3, wherein said connection element is an axle able to be axially connected.

5. The wheelchair power-assisted wheel of claim 1, wherein said power-driven wheel and said power provider arranged in an alternative and non-overlapping way.

6. The wheelchair power-assisted wheel of claim 1, wherein said pressure is force induced by said power-driven wheel and said power provider arranged in an alternative way.

7. The wheelchair power-assisted wheel of claim 1, wherein said power-driven wheel further comprises:
a rim; and
a power driver arranged under said front part of said substrate and connected with said rim, and said power driver is electrically connected with said power provider and receives said power provided by said power provider to rotate said rim.

8. The wheelchair power-assisted wheel of claim 7, wherein said power driver is a direct-current (DC) brushless motor, a DC brush motor or a rim motor.

9. The wheelchair power-assisted wheel of claim 1, wherein said power provider is a battery or a chargeable battery.

10. The wheelchair power-assisted wheel of claim 1, wherein said wheelchair is a manual wheelchair.
